(19) United States
(12) Patent Application Publication
(10) Pub. No.: US 2018/0283352 A1
(43) Pub. Date: Oct. 4, 2018

(54) Method for Preventing Wind Turbine Rotor Blade Tower Strikes

(71) Applicant: General Electric Company, Schenectady, NY (US)

(72) Inventors: Bryan Paul Williams, Greenville, SC (US); Mark L. Cook, Tehachapi, CA (US); Danian Zheng, Fairfield, CT (US)

(21) Appl. No.: 15/475,349

(22) Filed: Mar. 31, 2017

(51) Int. Cl. F03D 7/04; F03D 17/00; F03D 7/02; F03D 80/80

(52) U.S. Cl. CPC F03D 7/042; F03D 17/00; F03D 7/0204; F03D 80/80; F03D 7/0276; F03D 7/0288; F03D 7/0224

(57) ABSTRACT

The present disclosure is directed to a method for preventing a tower strike of a tower of a wind turbine by a rotor blade thereof. The method includes mounting a plurality of sensors circumferentially around the tower at a height generally aligning with a blade tip of the rotor blade in a rotor plane as the blade tip passes through a six o'clock position. Further, the method includes generating, via one or more of the plurality of sensors, at least one distance signal representative of a distance between the blade tip of the rotor blade and the tower as the rotor blade passes by one or more of the sensors. Thus, the method also includes implementing, via a wind turbine controller, a corrective action if the distance signal exceeds a predetermined threshold.

### FIELD OF THE INVENTION

The present disclosure relates in general to wind turbine, and more particularly to methods for preventing wind turbine rotor blade tower strikes.

### BACKGROUND OF THE INVENTION

Wind power is considered one of the cleanest, most environmentally friendly energy sources presently available, and wind turbines have gained increased attention in this regard. A modern wind turbine typically includes a tower, a generator, a gearbox, a nacelle, and one or more rotor blades. The rotor blades capture kinetic energy of wind using known airfoil principles. The rotor blades transmit the kinetic energy in the form of rotational energy so as to turn a shaft coupling the rotor blades to a gearbox, or if a gearbox is not used, directly to the generator. The generator then converts the mechanical energy to electrical energy that may be deployed to a utility grid.

During operation of the wind turbine, the rotor blades can become worn, damaged, or deflected. For example, tip separation, delamination, or deflection may change the shape of the rotor blade. In addition, the tower may become damaged. Such tip separation, delamination, deflection, and/or tower damage generally increases the risk of a rotor blade tower strike. Repair of blade tower strikes can be very expensive due to the costs associated with repair and/or replacement of the rotor blades and/or the tower as well as downtime of the wind turbine.

Thus, design modifications of the wind turbine, such as nacelle upward tilt, blade coning, and blade pre-bend have been implemented on modern wind turbines to mitigate such blade tower strikes. However, it is still important to understand the design margin for blade tower clearance on a functioning wind turbine.

As such, the present disclosure is continuously seeking new and improved methods for preventing wind turbine rotor blade tower strikes. Accordingly, the present disclosure is directed to methods for continuously measuring blade tip deflection via an array of sensors so as to prevent rotor blade tower strikes.

### BRIEF DESCRIPTION OF THE INVENTION

Aspects and advantages of the invention will be set forth in part in the following description, or may be obvious from the description, or may be learned through practice of the invention.

In one aspect, the present disclosure is directed to a method for preventing a tower strike of a tower of a wind turbine by a rotor blade thereof. The method includes mounting a plurality of sensors circumferentially around the tower at a height generally aligning with a blade tip of the rotor blade in a rotor plane as the blade tip passes through a six o'clock position. Further, the method includes generating, via one or more of the plurality of sensors, at least one distance signal representative of a distance between the blade tip of the rotor blade and the tower as the rotor blade passes by one or more of the sensors. Thus, the method also includes implementing, via a wind turbine controller, a corrective action if the distance signal exceeds a predetermined threshold.

In one embodiment, the method includes generating, via one or more of the plurality of sensors, a plurality of distance signals representing the distance between the blade tip of the rotor blade and the tower as the rotor blade passes by the sensors and filtering the plurality of distance signals. In another embodiment, if the rotor blade passes equally between two of the plurality of sensors, the method may include simultaneously generating, via the two sensors, a plurality of distance signals representing the distance between the blade tip of the rotor blade and the tower.

In another embodiment, the step of implementing the corrective action may include implementing a thrust reduction action. More specifically, in certain embodiments, the step of implementing the thrust reduction action may include increasing a pitch angle of the rotor blade, increasing a torque demand of a generator of the wind turbine, reducing a rotor speed of the wind turbine, yawing a nacelle of the wind turbine, and/or modifying a tip-speed-ratio (TSR) of the rotor blade. In additional embodiments, the step of implementing the corrective action may further include modifying a turbine speed set point and at least one of a power set point or a torque set point of the wind turbine after implementing the thrust reduction action.

In several embodiments, the method may also include checking one or more operating conditions of the wind turbine before implementing the thrust reduction action.

In additional embodiments, the method may include determining a yaw position of a rotor of the wind turbine, storing the yaw position in a memory device of the wind turbine controller, and adjusting the corrective action based on the yaw position.

In another embodiment, the sensor(s) may include any suitable sensor including but not limited to a laser sensor, a video sensor, a radio sensor, a proximity sensor, an ultrasonic sensor, or similar. In addition, the method may further include mounting the plurality of sensors circumferentially around the tower via at least one of one or more magnets, one or more fasteners, an adhesive, a track, or combinations thereof. Further, in certain embodiments, the method may include evenly spacing the plurality of sensors circumferentially around the tower.

In yet another embodiment, the method may include communicatively coupling each of the plurality of sensors to the controller via a power cable or wireless communication.

In another aspect, the present disclosure is directed to a wind turbine. The wind turbine includes a tower extending from a support surface, a nacelle mounted atop the tower, a rotor mounted to the nacelle and having a rotatable hub and at least one rotor blade extending therefrom, a plurality of sensors, and a wind turbine controller. Further, the sensors are circumferentially mounted around the tower at a height generally aligning with a blade tip of the rotor blade in a rotor plane as the blade tip passes through a six o'clock position. Further, the sensors may be arranged in any suitable number of rows. In addition, one or more of the sensors is configured to generate a plurality of distance signals representative of a distance between the blade tip of the rotor blade and the tower as the rotor blade passes by one or more of the sensors. Thus, the wind turbine controller is configured to implement a corrective action if the distance signal exceeds a predetermined threshold. It should also be understood that the wind turbine may further include any of the additional features and/or embodiments as described herein.

In yet another aspect, the present disclosure is directed to a method for preventing a rotor blade tower strike of a tower of a wind turbine. The method includes mounting a plurality of sensors circumferentially around the tower at a height generally aligning with a blade tip of the rotor blade in a rotor plane as the blade tip passes through a six o'clock position. Further, the method includes mounting one or more additional sensors on a nacelle of the wind turbine. The method also includes generating, via one or more of the plurality of sensors, at least one distance signal representative of a distance between the rotor blade and the tower. Moreover, the method includes implementing, via a wind turbine controller, a corrective action if the distance signal exceeds a predetermined threshold. It should also be understood that the method may further include any of the additional steps and/or features as described herein.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a wind turbine according to the present disclosure;

FIG. 2 illustrates a perspective view of a simplified, internal view of one embodiment of a nacelle of a wind turbine according to the present disclosure;

FIG. 3 illustrates a schematic diagram of one embodiment of suitable components that may be included in a wind turbine controller according to the present disclosure;

FIG. 4 illustrates an elevation view of one embodiment of a tower having an array of sensors mounted thereon according to the present disclosure;

FIG. 5 illustrates a flow diagram of one embodiment of a method for preventing a wind turbine rotor blade tower strike according to the present disclosure;

FIG. 6 illustrates a partial, front view of one embodiment of a wind turbine rotor according to the present disclosure, particularly illustrating a rotor plane of the rotor;

FIG. 7 illustrates a top view of one embodiment of a wind turbine tower according to the present disclosure, particularly illustrating a yaw range of one of the sensors;

FIG. 8 illustrates a top view of one embodiment of a wind turbine tower according to the present disclosure, particularly illustrating a plurality of sensors mounted circumferentially about the tower;

FIG. 9 illustrates a schematic view of one embodiment of a sensor according to the present disclosure;

FIG. 10 illustrates a partial, perspective view of one embodiment of a wind turbine according to the present disclosure, particularly illustrating a measured distance between the tower and a blade tip of the rotor blade generated by a sensor;

FIG. 11 illustrates a schematic view of one embodiment of various data processing steps implemented by a controller so as to prevent wind turbine rotor blade tower strikes according to the present disclosure; and

FIG. 12 illustrates a schematic view of one embodiment of various control steps implemented by a controller so as to prevent wind turbine rotor blade tower strikes according to the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

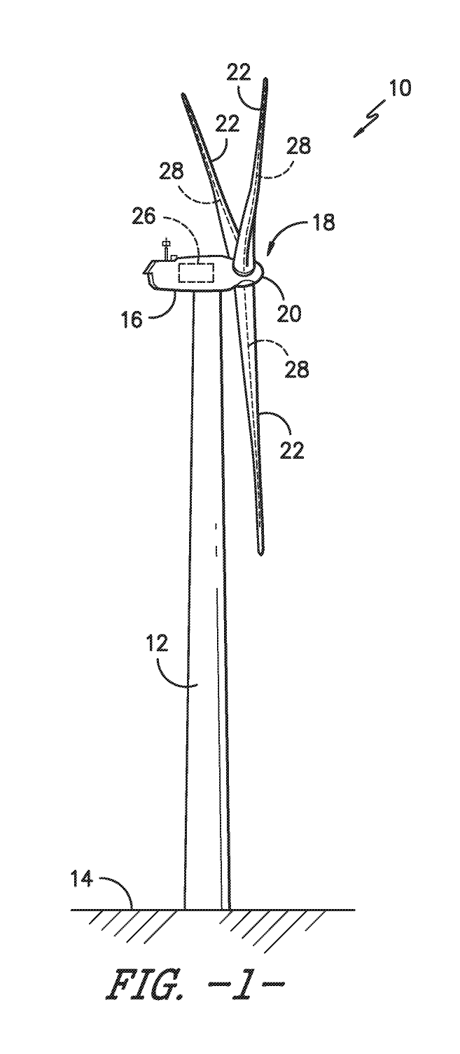

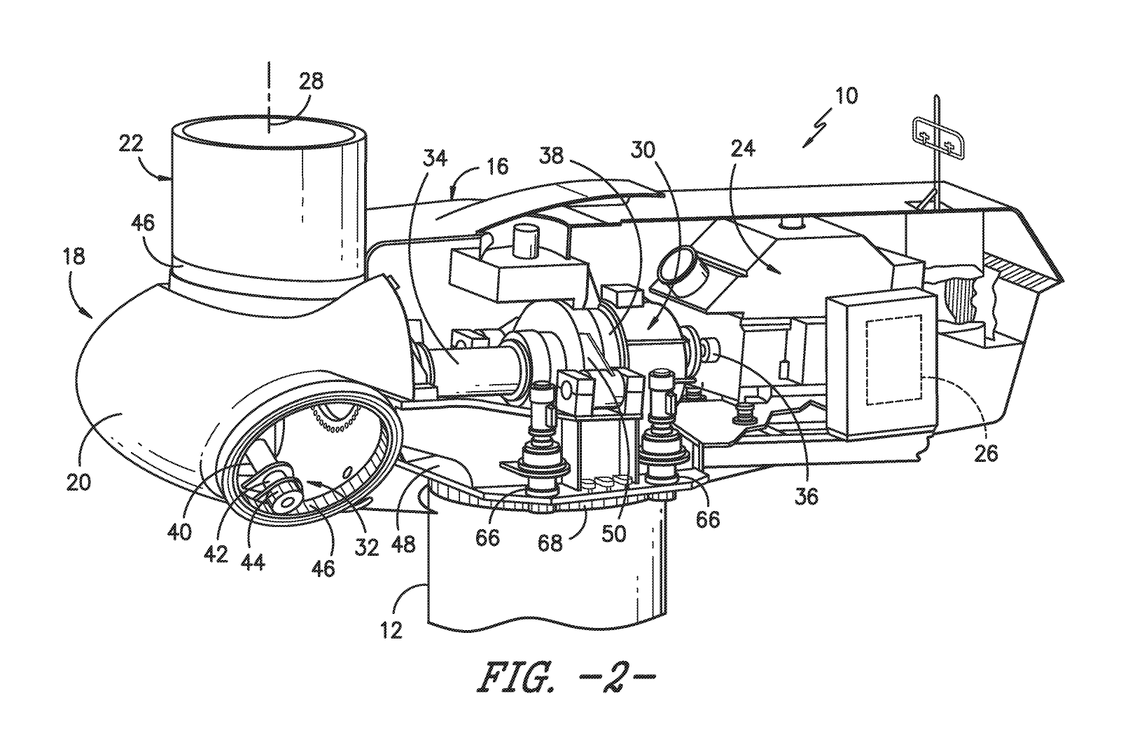

Referring now to the drawings, FIG. 1 illustrates a perspective view of one embodiment of a wind turbine 10 according to the present disclosure. As shown, the wind turbine 10 generally includes a tower 12 extending from a support surface 14, a nacelle 16 mounted on the tower 12, and a rotor 18 coupled to the nacelle 16. The rotor 18 includes a rotatable hub 20 and at least one rotor blade 22 coupled to and extending outwardly from the hub 20. For example, in the illustrated embodiment, the rotor 18 includes three rotor blades 22. However, in an alternative embodiment, the rotor 18 may include more or less than three rotor blades 22. Each rotor blade 22 may be spaced about the hub 20 to facilitate rotating the rotor 18 to enable kinetic energy to be transferred from the wind into usable mechanical energy, and subsequently, electrical energy. For instance, the hub 20 may be rotatably coupled to an electric generator 24 (FIG. 2) positioned within the nacelle 16 to permit electrical energy to be produced.

The wind turbine 10 may also include a wind turbine controller 26 centralized within the nacelle 16. However, in other embodiments, the controller 26 may be located within any other component of the wind turbine 10 or at a location outside the wind turbine 10. Further, the controller 26 may be communicatively coupled to any number of the components of the wind turbine 10 in order to control the components. As such, the controller 26 may include a computer or other suitable processing unit. Thus, in several embodiments, the controller 26 may include suitable computer-readable instructions that, when implemented, configure the controller 26 to perform various different functions, such as receiving, transmitting and/or executing wind turbine control signals.

Referring now to FIG. 2, a simplified, internal view of one embodiment of the nacelle 16 of the wind turbine 10 shown in FIG. 1 is illustrated. As shown, the generator 24 may be coupled to the rotor 18 for producing electrical power from the rotational energy generated by the rotor 18. For example, as shown in the illustrated embodiment, the rotor 18 may include a main shaft 34 rotatable via a main bearing coupled to the hub 20 for rotation therewith. The main shaft 34 may, in turn, be rotatably coupled to a gearbox output shaft 36 of the generator 24 through a gearbox 30. Further, as shown, the gearbox 30 includes a gearbox housing 38 that is connected to a bedplate support frame 48 by one or more torque arms 50. As is generally understood, the main shaft 34 provides a low speed, high torque input to the gearbox 30 in response to rotation of the rotor blades 22 and the hub 20. The gearbox 30 then converts the low speed, high torque input to a high speed, low torque output to drive the gearbox output shaft 36 and, thus, the generator 24.

Each rotor blade 22 may also include a pitch adjustment mechanism 32 configured to rotate each rotor blade 22 about its pitch axis 28, depending on the wind speed and/or wind direction. As such, pitching the blades 22 directly affects the power output of the generator 24. More specifically, each pitch adjustment mechanism 32 may include a pitch drive motor 40 (e.g., any suitable electric, hydraulic, or pneumatic motor), a pitch drive gearbox 42, and a pitch drive pinion 44. In such embodiments, the pitch drive motor 40 may be coupled to the pitch drive gearbox 42 so that the pitch drive motor 40 imparts mechanical force to the pitch drive gearbox 42. Similarly, the pitch drive gearbox 42 may be coupled to the pitch drive pinion 44 for rotation therewith. The pitch drive pinion 44 may, in turn, be in rotational engagement with a pitch bearing 46 coupled between the hub 20 and a corresponding rotor blade 22 such that rotation of the pitch drive pinion 44 causes rotation of the pitch bearing 46. Thus, in such embodiments, rotation of the pitch drive motor 40 drives the pitch drive gearbox 42 and the pitch drive pinion 44, thereby rotating the pitch bearing 46 and the rotor blade 22 about the pitch axis 28. Similarly, the wind turbine 10 may include one or more yaw drive mechanisms 66 communicatively coupled to the controller 26, with each yaw drive mechanism(s) 66 being configured to change the angle of the nacelle 16 relative to the wind (e.g., by engaging a yaw bearing 68 of the wind turbine 10).

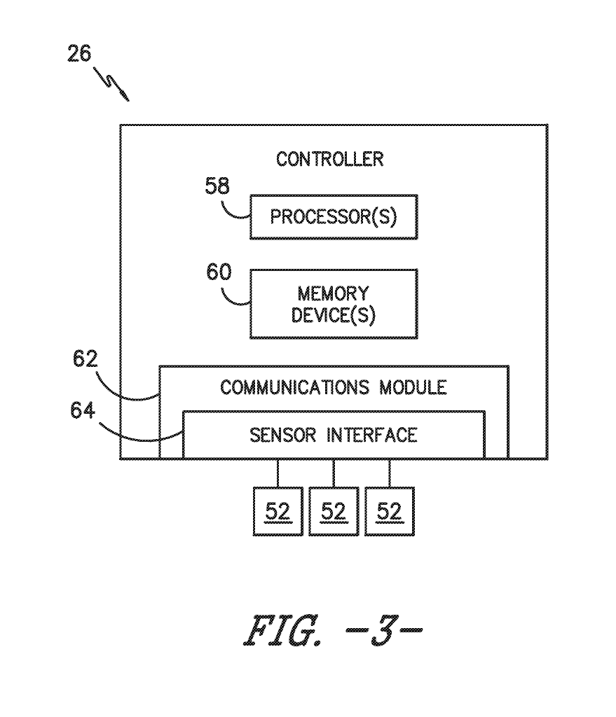

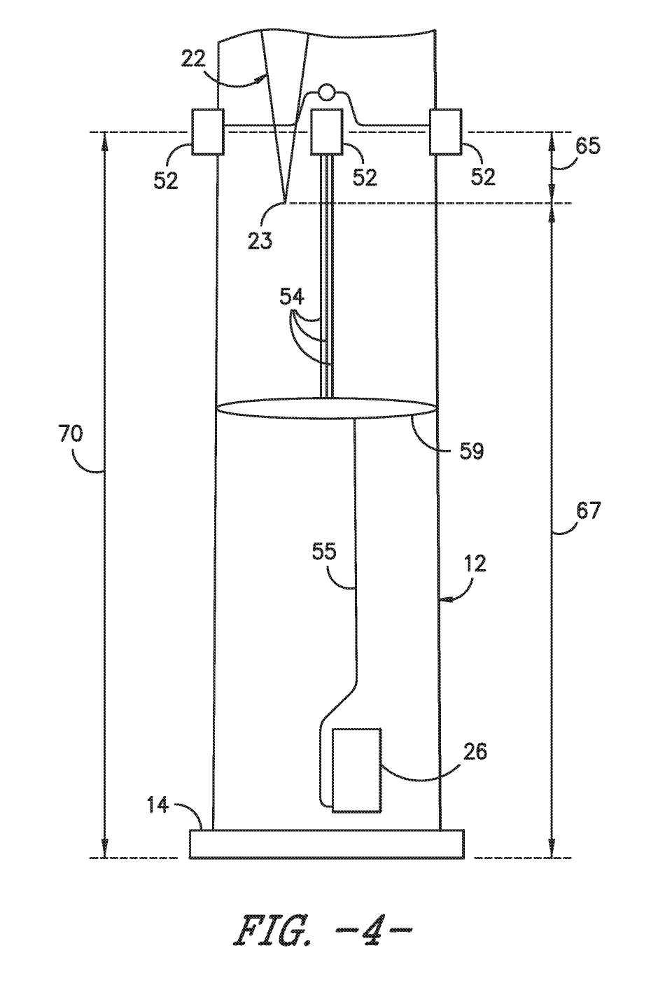

Referring now to FIG. 3, there is illustrated a block diagram of one embodiment of suitable components that may be included within the controller 26 according to the present disclosure. As shown, the controller 26 may include one or more processor(s) 58 and associated memory device(s) 60 configured to perform a variety of computer-implemented functions (e.g., performing the methods, steps, calculations and the like and storing relevant data as disclosed herein). Additionally, the controller 26 may also include a communications module 62 to facilitate communications between the controller 26 and the various components of the wind turbine 10. Further, the communications module 62 may include a sensor interface 64 (e.g., one or more analog-to-digital converters) to permit signals transmitted from one or more sensors 52 to be converted into signals that can be understood and processed by the processors 58. It should be appreciated that the sensors 52 may be communicatively coupled to the communications module 62 using any suitable means. For example, as shown in FIG. 3, the sensors 52 are coupled to the sensor interface 64 via a wired connection using a plurality of power cables 54. In such embodiments, as further shown in FIG. 4, the power cable(s) 54 may be further routed through the tower 12 through any platforms 59 mounted therein (if any) and to the controller 26, e.g. via a conductor cable 55. However, in other embodiments, the sensors 52 may be coupled to the sensor interface 64 via a wireless connection, such as by using any suitable wireless communications protocol known in the art.

As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 60 may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) 60 may generally be configured to store suitable computer-readable instructions that, when implemented by the processor(s) 58, configure the controller 26 to perform various functions including, but not limited to, transmitting suitable control signals to implement corrective action(s) in response to a distance signal exceeding a predetermined threshold as described herein, as well as various other suitable computer-implemented functions.

The sensors 52 described herein may include any suitable sensor now known or later developed in the art that is capable of measuring a distance. For example, in certain embodiments, the sensor(s) 52 may include a laser sensor, a video sensor, a radio sensor, a proximity sensor, an ultrasonic sensor, an optical sensor, or similar. More specifically, in certain embodiments, the sensors 52 may include laser distance sensors that can withstand water, dust, and other environmental conditions experienced at a wind turbine site.

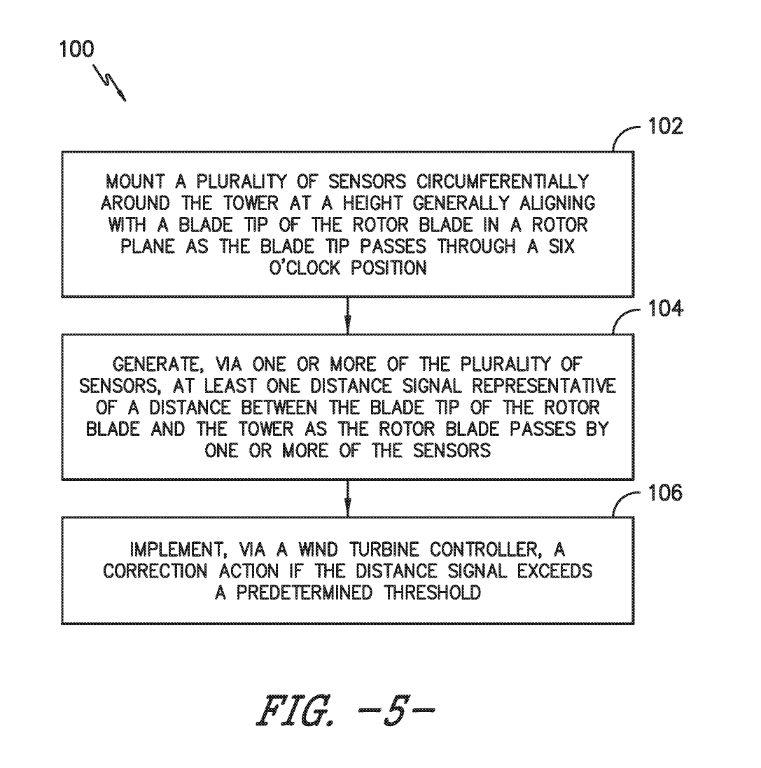

Referring now to FIGS. 4-12, various embodiments of a system and method for preventing a tower strike of the tower 12 of the wind turbine 10 by one of the rotor blades 22 are illustrated. More specifically, FIG. 5 illustrates a flow diagram of one embodiment of a method 100 for preventing a wind turbine rotor blade tower strike. As shown at 102, the method 100 includes mounting a plurality of the sensors 52 circumferentially around the tower 12 at a height 70 generally aligning with a blade tip 23 of the rotor blade 22 in a rotor plane 56 as the blade tip 23 passes through a six o'clock position (FIG. 4). In other words, the sensors 52 are generally mounted on the wind turbine tower 12 at a height 70 where one of the rotor blades 22 sweeps by the sensor 52 during operation of the wind turbine 10. In addition, as shown in FIG. 4, it should be understood that the blade tip 23 of the rotor blade 22 and the sensor height 70 may not exactly align, but may vary by a certain difference indicated by reference number 65. For example, in certain embodiments, the ratio between the height 70 of the sensors 52 and the height 67 of the blade tip 23 (i.e. the difference 65) may vary from about 5% to about 20%.

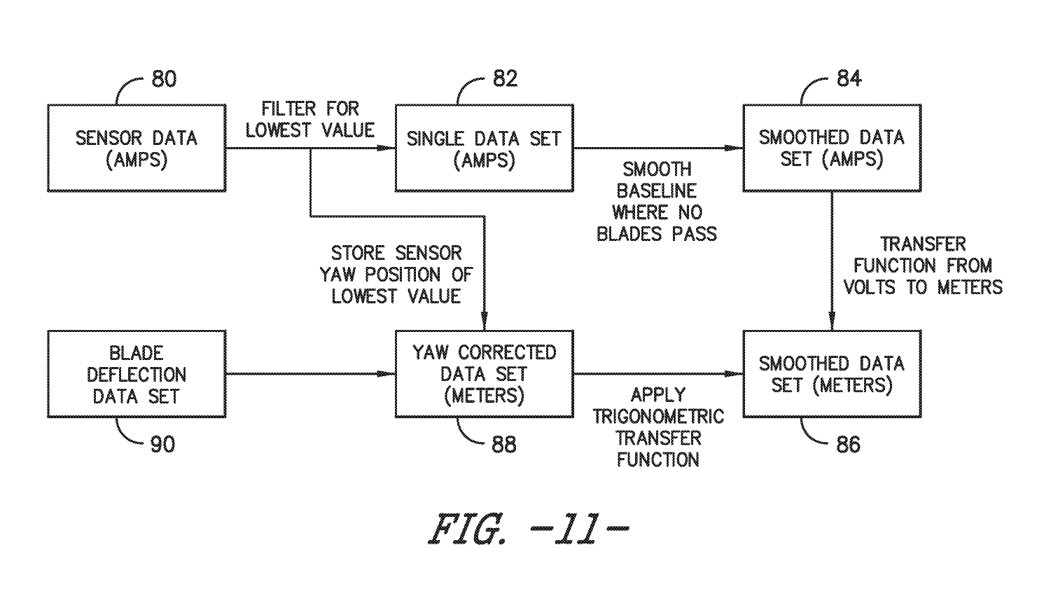

In addition, as shown, the sensors 52 may be mounted in a single row (FIG. 4) or multiple rows (FIG. 10). In further embodiments, as shown in FIG. 10, additional sensors 53 may be mounted on the nacelle 16, e.g. to determine blade deflection changes and bending modes at different rotor positions. For example, as shown, one or more sensors 53 may be mounted atop the nacelle 16 facing upward to capture the twelve o'clock position of the rotor blades 22. In addition, as shown, the additional sensors 53 may be mounted to the sides of the nacelle 16 to capture the three and nine o'clock positions. Such sensors 53 have a longer readable range than sensors 52.

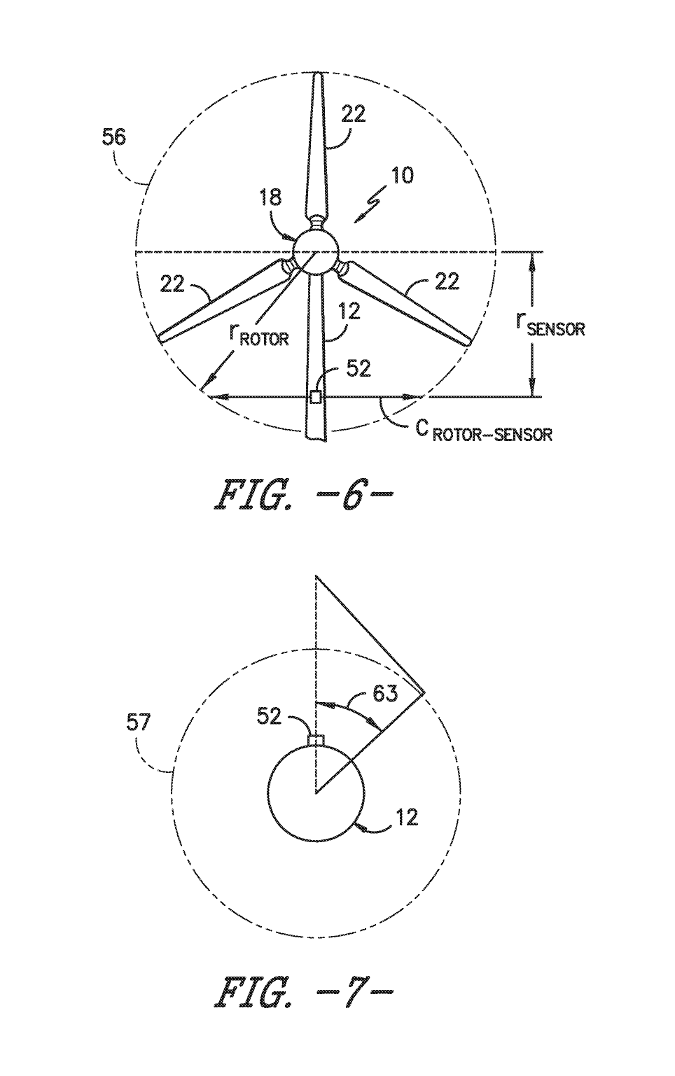

Further, as shown in FIGS. 6 and 7, a snap shot of one embodiment of a flat rotor plane 56 that a single sensor 52 measures, as well as the yaw range 63 of such sensor 52 are illustrated. In certain embodiments, the desired range 63 for each sensor 52 may be about 60 degrees, plus or minus about 30 degrees from each sensor position with the sensors 52 being mounted from about one to about two meters from the blade tip's minimum position. The required number of sensors 52 changes down the tower 12, which is closer to measuring the actual blade tip minimum point on the rotor plane. As such, an appropriate number of sensors 52 can be determined and mounted circumferentially around the tower 12 so as to cover the entire yaw span 57 of the tower 12. In addition, as shown in FIG. 6, the rotor radius rᵣₒₜₒᵣ, the sensor radius rₛₑₙₛₒᵣ, and the locations that the sensors 52 can measure clearance Cᵣₒₜₒᵣ₋ₛₑₙₛₒᵣ are illustrated. As shown in the illustrated embodiment, the rotor radius rᵣₒₜₒᵣ and the sensor radius rₛₑₙₛₒᵣ are substantially equal, however, as mentioned, the rotor radius rᵣₒₜₒᵣ and the sensor radius rₛₑₙₛₒᵣ may vary by a certain distance 65 as shown in FIG. 4.

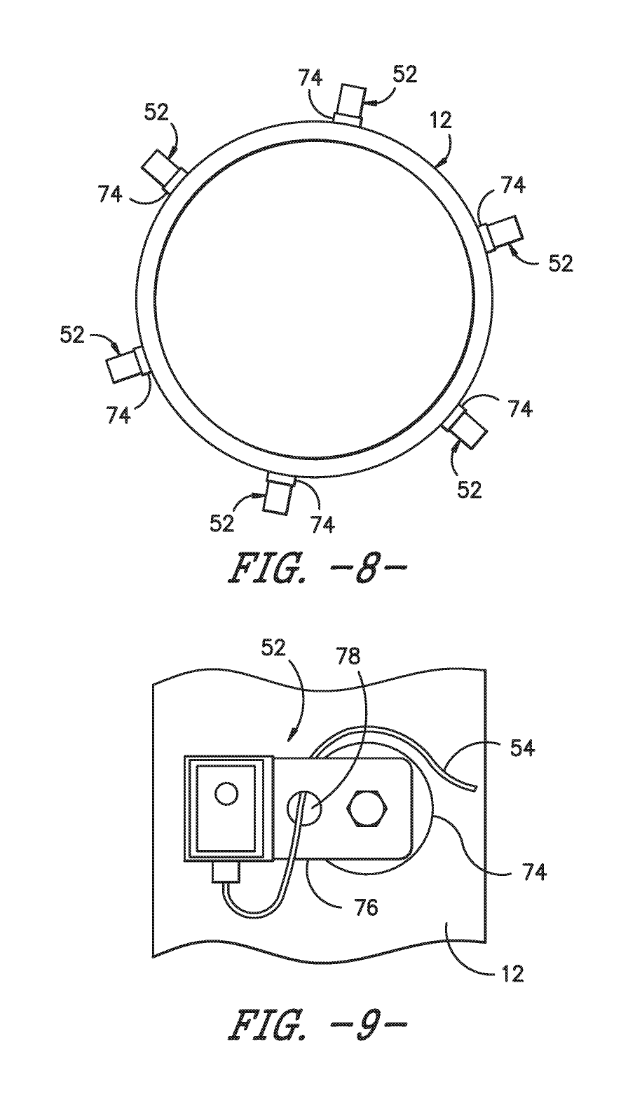

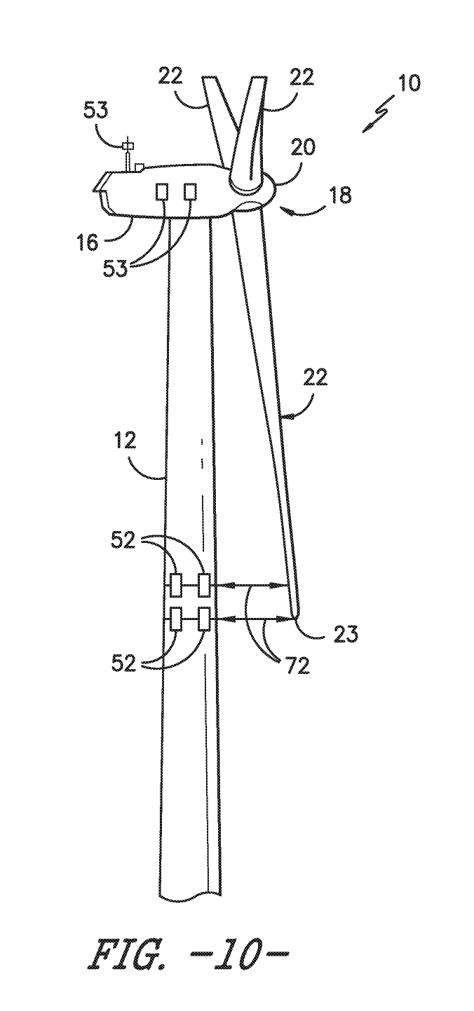

Referring now to FIGS. 8 and 9, the array of sensors 52 may be circumferentially mounted around the tower 12 via any suitable mounting device 74. For example, as shown, each of the sensors 52 may be secured to the tower 12 via at least one magnet 74. In alternative embodiments, the sensors 52 may be secured to the tower 12 via one or more fasteners, an adhesive, a track, and/or combinations thereof. More specifically, as shown in FIG. 9, each sensor 72 may be secured to a bracket 76 having an opening 78 for the power cable 54 that is routed therethrough. The bracket 76 can then be secured to the magnet 74 that is mounted to the tower 12. In addition, as shown in FIG. 8, the sensors 52 may be evenly spaced circumferentially around the tower 12. Alternatively, the sensors 52 may be unevenly spaced around the tower 12.

Referring back to FIG. 5, as shown at 104, the method 100 includes generating, via one or more of the plurality of sensors 52, at least one distance signal representative of a distance between the blade tip 23 of the rotor blade 22 and the tower 12 as the rotor blade 22 passes by one or more of the sensors 52. For example, as shown in FIG. 10, one embodiment of the distance 72 between the blade tip 23 of the rotor blade 22 and the tower 12 as the rotor blade 22 passes by the sensor 52 is illustrated.

In further embodiments, the method 100 may include determining at least one wind condition of the wind turbine 10 and adjusting the distance signals based on the at least one wind condition. For example, in certain embodiments, the wind condition may include wind direction, wind speed, or any other wind and/or weather parameter. Thus, in such embodiments, the controller 26 may be configured to plot the distance signals against an average wind speed. As expected, the rotor blade 22 typically passes closest to the tower 12 around rated wind speeds. Accordingly, such wind and/or weather conditions can be considered by the controller 26 when evaluating the likelihood of a rotor blade tower strike.

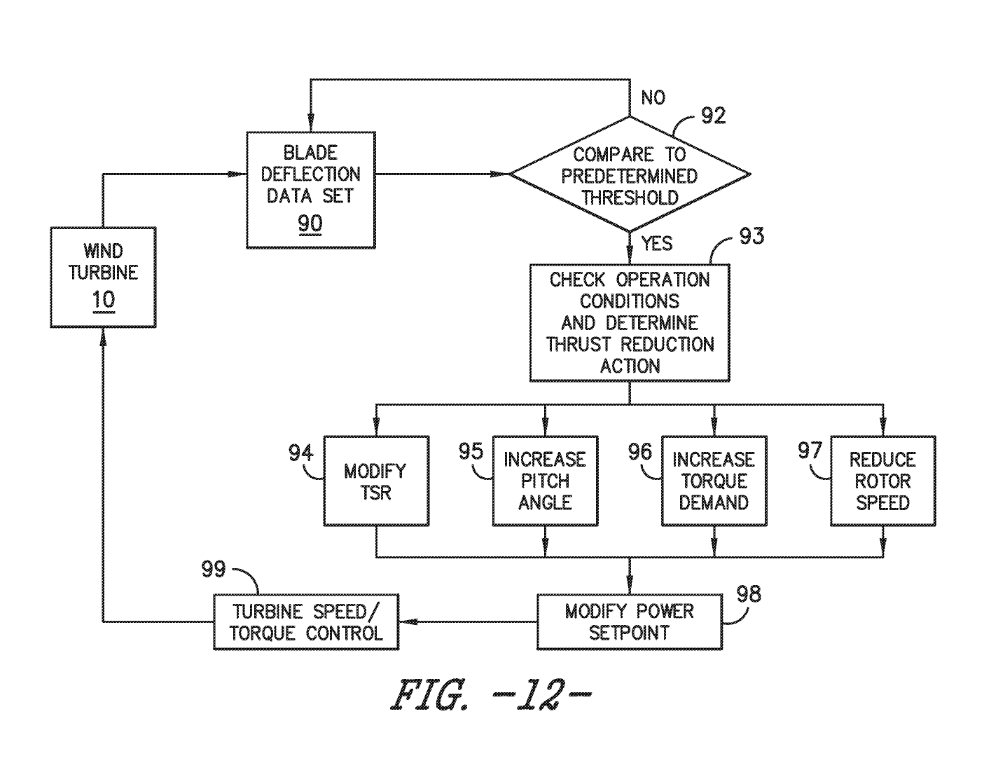

In additional embodiments, the method 100 may include generating a plurality of distance signals via the sensors 52 that are representative of the distance 72 between the blade tip 23 of the rotor blade 22 and the tower 12 as the rotor blade 22 passes by the sensor(s) 52 and filtering the plurality of distance signals. For example, as shown in FIGS. 11 and 12, the controller 26 may also be further configured to filter the plurality of distance signals 80 so as to obtain the lowest value therein. More specifically, the data signals for the sensors 52 may be filtered for non-zero values, which is how the controller 26 chooses the appropriate sensor with data at any given time. Further, as shown at 82, the controller 26 then coverts the sensor data 80 into a single data set. As shown at 84, the controller 26 is configured to smooth the sensor data, e.g. where no rotor blades pass. In addition, as shown at 86, the controller 26 may use a transfer function to convert the volts (amps) obtained from the sensors 52 to a distance measurement, e.g. meters. In additional embodiments, the controller 26 may further determine a yaw position of the rotor 18 of the wind turbine 10, e.g. a yaw position of the lowest value, and store the yaw position in the memory device 60 of the wind turbine controller 26. Thus, as shown at 88, the controller 26 may adjust the smoothed data set 86 based on the yaw position. For example, as shown, the controller 26 may apply a trigonometric transfer function to the smoothed data set 86 to obtain a yaw corrected data set 88. More specifically, the yaw position may be used, knowing the location of the sensors 52, to calculate the trigonometric off-set to give a true blade to tower distance. Such steps maintain all data peaks if the wind turbine 10 is yawed in between two sensors, rather than just choosing the closest sensor to the yaw position and deleting the adjacent sensor's reading.

Accordingly, as shown at 90, the blade deflection data set can be used to implement a corrective action so as to prevent a rotor blade tower strike. Referring back to FIG. 5, as shown at 106, the method 100 includes implementing a corrective action if the distance signal (e.g. the blade deflection data set 90) exceeds the predetermined threshold via the wind turbine controller 26. More specifically, as shown in FIG. 12, from the blade deflection data set 90, the controller 26, or another control unit dedicated for this purpose, can determine whether a corrective action is needed. For example, as shown at 92, the controller 26 is configured to compare the blade deflection data set 90 to a predetermined threshold. More specifically, in particular embodiments, the predetermined threshold may represent a distance that indicates a certain amount of deflection or deformation of the rotor blade 22 is present. In particular embodiments, as shown at 93, the controller 26 may also check one or more operating conditions of the wind turbine 10 after the comparison, e.g. to see if the exceedance is being caused by such operating conditions rather than blade deflection. For example, the pitch angle, yaw angle, and various other operating conditions may cause the rotor blades 22 to sweep past the tower 12 at a reduced distance 72 (FIG. 10).

If the predetermined threshold is exceeded, the controller 26 is configured to implement one or more corrective actions so as to prevent a rotor blade tower strike. For example, in certain embodiments, the corrective action(s) may include implementing a thrust reduction action 93. More specifically, in such embodiments, the thrust reduction action(s) may include increasing a pitch angle 95 of the rotor blade 22, increasing a torque demand 96 of a generator 24 of the wind turbine 10, reducing a rotor speed 97 of the wind turbine 10, yawing the nacelle 16 of the wind turbine 10, and/or modifying a tip-speed-ratio (TSR) 94 of the rotor blade 22. Accordingly, as shown at 99, the controller 26 is configured to provide appropriate operational set points for wind turbine 10 so as to maintain a desired clearance between the tower 12 and the rotor blades 22. For example, in several embodiments, the step of implementing the corrective action may include modifying a turbine speed set point and at least one of a power set point or a torque set point of the wind turbine after implementing the thrust reduction action. More specifically, in certain embodiments, the controller 26 may modify the turbine speed set point and the torque set point of the wind turbine 10 so as to avoid rotor blade tower strikes. In alternative embodiments, the controller 26 may modify the turbine speed set point and a power set point 98 of the wind turbine 10 so as to avoid rotor blade tower strikes.

Exemplary embodiments of systems and methods for a wind turbine are described above in detail. The systems and methods are not limited to the specific embodiments described herein, but rather, components of the systems and/or steps of the methods may be utilized independently and separately from other components and/or steps described herein, and are not limited to practice with only the wind turbine systems as described herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for preventing a tower strike of a tower of a wind turbine by a rotor blade thereof, the method comprising:
mounting a plurality of sensors circumferentially around the tower at a height generally aligning with a blade tip of the rotor blade in a rotor plane as the blade tip passes through a six o'clock position;
generating, via one or more of the plurality of sensors, at least one distance signal representative of a distance between the blade tip of the rotor blade and the tower as the rotor blade passes by one or more of the sensors; and,
implementing, via a wind turbine controller, a corrective action if the distance signal exceeds a predetermined threshold.

2. The method of claim 1, further comprising:
generating, via one or more of the plurality of sensors, a plurality of distance signals representing the distance between the blade tip of the rotor blade and the tower as the rotor blade passes by the sensors; and,
filtering the plurality of distance signals to obtain a single distance signal.

3. The method of claim 1, wherein, if the rotor blade passes equally between two of the plurality of sensors, the method further comprises simultaneously generating, via the two sensors, a plurality of distance signals representing the distance between the blade tip of the rotor blade and the tower.

4. The method of claim 1, wherein implementing the corrective action further comprises implementing a thrust reduction action, wherein implementing the thrust reduction action comprises at least one of increasing a pitch angle of the rotor blade, increasing a torque demand of a generator of the wind turbine, reducing a rotor speed of the wind turbine, yawing a nacelle of the wind turbine, or modifying a tip-speed-ratio (TSR) of the rotor blade.

5. The method of claim 4, wherein implementing the corrective action further comprises modifying a turbine speed set point and at least one of a power set point or a torque set point of the wind turbine after implementing the thrust reduction action.

6. The method of claim 1, further comprising checking one or more operating conditions of the wind turbine before implementing the thrust reduction action.

7. The method of claim 1, further comprising:
determining a yaw position of a rotor of the wind turbine;
storing the yaw position in a memory device of the wind turbine controller; and,
adjusting the corrective action based on the yaw position.

8. The method of claim 1, wherein the plurality of sensors comprise at least one of a laser sensor, a video sensor, a radio sensor, a proximity sensor, or an ultrasonic sensor.

9. The method of claim 1, further comprising mounting the plurality of sensors circumferentially around the tower via at least one of one or more magnets, one or more fasteners, an adhesive, a track, or combinations thereof.

10. The method of claim 1, further comprising evenly spacing the plurality of sensors circumferentially around the tower.

11. The method of claim 1, further comprising communicatively coupling each of the plurality of sensors to the controller via a power cable or wireless communication.

12. A wind turbine, comprising:
a tower extending from a support surface;
a nacelle mounted atop the tower;
a rotor mounted to the nacelle, the rotor having a rotatable hub and at least one rotor blade extending therefrom;
a plurality of sensors circumferentially mounted around the tower at a height generally aligning with a blade tip of the rotor blade in a rotor plane as the blade tip passes through a six o'clock position, one or more of the plurality of sensors configured to generate a plurality of distance signals representative of a distance between the blade tip of the rotor blade and the tower as the rotor blade passes by one or more of the sensors; and,
a wind turbine controller configured to implement a corrective action if the distance signal exceeds a predetermined threshold.

13. The wind turbine of claim 12, wherein the plurality of sensors comprise a plurality of rows of sensors.

14. The wind turbine of claim 12, wherein the plurality of sensors comprise at least one of a laser sensor, a video sensor, a radio sensor, a proximity sensor, or an ultrasonic sensor.

15. The wind turbine of claim 12, wherein the plurality of sensors are circumferentially mounted around the tower via at least one of one or more magnets, one or more fasteners, an adhesive, a track, or combinations thereof.

16. The wind turbine of claim 12, wherein the plurality of sensors are evenly spaced circumferentially around the tower.

17. The wind turbine of claim 12, wherein each of the plurality of sensors are communicatively coupled to the controller via a power cable or wireless communication.

18. The wind turbine of claim 12, wherein the corrective action further comprises at least one of a thrust reduction action, wherein the thrust reduction action comprises at least one of increasing a pitch angle of the rotor blade, increasing a torque demand of a generator of the wind turbine, reducing a rotor speed of the wind turbine, yawing a nacelle of the wind turbine, or modifying a tip-speed-ratio (TSR) of the rotor blade.

19. The wind turbine of claim 17, wherein implementing the corrective action further comprises modifying a turbine speed set point and at least one of a power set point or a torque set point of the wind turbine after implementing the thrust reduction action.

20. A method for preventing a rotor blade tower strike of a tower of a wind turbine, the method comprising:
mounting a plurality of sensors circumferentially around the tower at a height generally aligning with a blade tip of the rotor blade in a rotor plane as the blade tip passes through a six o'clock position;
mounting one or more additional sensors on a nacelle of the wind turbine;
generating, via one or more of the plurality of sensors, at least one distance signal representative of a distance between the rotor blade and the tower; and,
implementing, via a wind turbine controller, a corrective action if the distance signal exceeds a predetermined threshold.
